(19) United States
(12) Patent Application Publication
(10) Pub. No.: US 2019/0005237 A1
(43) Pub. Date: Jan. 3, 2019

(54) METHOD AND APPARATUS FOR IDENTIFYING, PREDICTING, PREVENTING NETWORK MALICIOUS ATTACKS

(71) Applicants: Paul J. Long, San Francisco, CA (US); Ian L. Sayers, South Shields (GB)

(72) Inventors: Paul J. Long, San Francisco, CA (US); Ian L. Sayers, South Shields (GB)

(21) Appl. No.: 16/020,573

(22) Filed: Jun. 27, 2018

Related U.S. Application Data
(60) Provisional application No. 62/527,449, filed on Jun. 30, 2017.

(51) Int. Cl. G06F 21/56; G06N 3/08

(52) U.S. Cl. CPC G06F 21/56; G06N 3/0445; G06N 3/084

(57) ABSTRACT

One embodiment of this invention describes a method and apparatus for identifying, predicting, and preventing malicious attacks against low complexity sensors or devices (sensors/devices) on a network through the use of an Artificial Neural Network (ANN) which is defined as a connectionist system (i.e. interconnected networks) functioning as a computing system inspired by living neural networks (e.g. the human brain). An ANN employs Machine Learning computational models that, without being programmed with any task-specific rules, can “learn” capabilities such as image recognition by simply considering relevant examples. This approach is similar to how a person might learn a new task. There are many forms and types of malicious attacks that are sometimes more commonly referred to as cyber attacks. In one instance of this invention the malicious attacks are identified by organizing and classifying encryption keys and/or messages sent to or received from a sensor/device. Additionally this invention can predict emerging attack techniques against sensors/devices in order to prevent the spread of malicious attacks thereby protecting and securing critical network data. However it should be clear from the description of the invention that the method could easily be adapted to other types of networks to provide comparable levels of analysis and protection against malicious attacks.

### BACKGROUND TO INVENTION

One embodiment of this invention describes a method and apparatus for identifying, predicting, and preventing malicious attacks against low complexity sensors or devices (sensors/devices) on a network through the use of an Artificial Neural Network (ANN) which is defined as a connectionist system (i.e. interconnected networks) functioning as a computing system inspired by living neural networks (e.g the human brain). An ANN employs Machine Learning computational models that, without being programmed with any task-specific rules can “learn” capabilities such as image recognition by simply considering relevant examples. This approach is similar to how a person might learn a new task. There are many forms and types of malicious attacks that are sometimes more commonly referred to as cyber attacks. In one instance of this invention the malicious attacks are identified by organizing and classifying encryption keys and/or messages sent to or received from a sensor/device. Additionally this invention can predict emerging attack techniques against sensors/devices in order to prevent the spread of malicious attacks thereby protecting and securing critical network data. However it should be clear from the description of the invention that the method could easily be adapted to other types of networks to provide comparable levels of analysis and protection against malicious attacks.

Current systems rely upon the end devices or the humans using them to realize that they have been attacked. There is no warning of an attack, nor monitoring of systems to advise a user of any growing/impending attacks, or more importantly to be able to identify and classify a new method of attack in its infancy. The reason is that virtually all systems must detect such attacks by themselves. This necessitates continually updating their virus/worm libraries/dictionaries (e.g. Microsoft™ Defender software) in order to monitor all incoming communications. As these current systems merely react to known/identified virus/hacks, this is not very useful in today's environment where new methods of security attacks are developed daily, since by the time a new method of hacking has been identified, analyzed, and a new library/dictionary is downloaded to the computer or sensor/device, the new hack has already impacted all vulnerable systems. Thus in practice, it is impossible for users and devices to detect and deal with the malicious attacks until either they or some other devices have already been compromised and an anti-hack response has been engineered and deployed. This is analogous to the annual rushed development of new human flu vaccines—first identify the flu strain, then develop a vaccine.

Due to cost constraints, low complexity sensors/devices do not have the CPU processing capacity to continually update software applications in order to function. Neither do such sensors/devices have the battery power to continually run or process:
mathematically intensive key exchange algorithms such as Diffie-Hellman key exchange, Public key infrastructure (PKI), Web of trust, or Password-authenticated key agreement (REF: 1).
Encryption standards such as AES, OpenPGP;
Hash standards such as MD5, SHA-1/2/3;
Wireless Standards such as WEP, WPA, A5-1/2 (REF: 2).
   Instead these sensors/devices typically rely on the simplest and least CPU intensive solutions by utilizing a limited number of permanent or semi-permanent pre-shared secret keys thus making them highly susceptible to hackers. It is therefore generally impossible for these sensors/devices to be able to fend off hackers, nor detect hacking activity. Nor would it be desirable to do so. For the above reasons it is essential that network wide protection is afforded to these sensors/devices as described in this invention.

Malicious attacks may originate from anywhere in the world, and it is normal practice for such attack sources to mask their originating locations. The origination point of a malicious attack can sometimes be identified, but this requires real-time capture of the communication data (aka “breadcrumbs”). Current methods require substantial computer processing power to monitor all sensors/devices in order to gather and track multiple instances of the malicious attack information as they appear, and to intelligently analyze the acquired data. The processing of the data needs to be done in near real-time in order for systems/operators to be alerted to attacks as they are launched, and prepare a method to intercept these attacks before they can cause any irreparable harm. There are currently several real-time sites which display malicious attacks globally such as Kapersky Labs, Norse, FireEye, Trend Micro and others (REF: 3), however these systems merely report what the hacked sensors/devices later acknowledge as an attack after it has managed to identify the attack from its installed anti-virus/worm/malware software. None of the above systems analyze the specific contents of the attack message, attack patterns, nor predict attacks. They merely show types of attacks such as HTTP, Denial of Service (DoS), etc. after the attack (REF: 4, REF: 5, REF: 6) and the device has already been compromised.

Modern cyber-security tools limit how quickly a response to an attack can be conducted. For example, Matt Wolff, Chief Data Scientist at Cylance, wrote in REF: 9 that “a network has been penetrated and malware has been placed on various machines in the network, with the purpose of exfiltration of sensitive information. The analyst in this case is charged with multiple tasks here; discover what exactly has been stolen, how it was stolen, and repair the system to prevent the same or similar attacks again . . . . Without the help of any form of machine learning system, the analyst would have a difficult time resolving these issues in a short timeframe. For example, to determine what has been stolen, perhaps file access logs or network traffic would be reviewed by the analyst, looking for access to sensitive files, or large amounts of data flowing out of the network. To determine how the attacked gained a persistent foothold in the network, malware analysis of the disk may be needed to try and track down known malware samples using signatures developed by other human analysts. Or perhaps an analysis of the running system, looking for unusual processes running or other anomalous behaviors would be conducted as part of the incident response”.

However, use of modern tools such as Machine Learning to help cybersecurity remains limited due to the generalized natured of machine learning and its inapplicability to cybersecurity threats which are continually evolving in real time as indicated by Robin Sommer and Vern Paxson in REF: 10 “compared with other intrusion detection approaches, machine learning is rarely employed in operational ‘real world’ settings . . . the task of finding attacks is fundamentally different from these other applications, making it significantly harder for the intrusion detection community to employ machine learning effectively.”

A further understanding of the nature and the advantages of particular embodiments disclosed herein may be realized by reference to the remaining portions of the patent application description and the attached drawings.

### REFERENCES

1. Key Exchange standards: https://en.wikipedia.org/wiki/Key_exchange
2. Encryption standards: https://en.wikipedia.org/wiki/Cryptography_standards
3. 9 Interesting Ways to Watch Cyber-attack in Real-time Worldwide. By Chandan Kumar. May 12, 2016. https://geekflare.com/real-time-cyber-attacks/
4. Top 10 Hacks: https://fossbytes.com/hacking-techniques/
5. 7 Sneak Attacks: http://www.infoworld.com/article/2610239/malware/7-sneak-attacks-used-by-today-s-most-devious-hackers.html
6. Top 5 Attacks of 2016: https://www.calyptix.com/top-threats/top-5-cyber-attack-types-in-2016-so-far/
7. Whitelist: https://en.wikipedia.org/wiki/Whitelist
8. Blacklist: https://en.wikipedia.org/wiki/Blacklist_(computing)
9. Applying Machine Learning to Advance Cyber Security Analytics: http://www.cybersecurity-review.com/industry-perspective/applying-machine-learning-to-advance-cyber-security-analytics/
10. Machine Learning for Network Intrusion Detection: http://ieeexplore.ieee.org/document/5504793/authors

### BRIEF DESCRIPTION OF THE DRAWINGS

One embodiment of this invention and its advantages may be described with reference to the associated figures:

FIG. 1. Block diagram of the Artificial Neural Network (ANN) Machine Learning System.

FIG. 2. Architecture of Process “Alpha”—Hack Identification Training, in the Artificial Neural Network (ANN) System.

FIG. 3. Architecture of Process “Beta”—Hack Prediction in the Artificial Neural Network (ANN) System.

### CROSS REFERENCE TO RELATED PATENT APPLICATIONS

U.S. patent Pending Ser. No. 15/494,993. METHOD AND APPARATUS FOR SECURING A SENSOR OR DEVICE. Filing Date: 24 Apr. 2017.

U.S. Provisional Patent No. 62/527,449. METHOD AND APPARATUS FOR IDENTIFYING, PREDICTING, PREVENTING NETWORK MALICIOUS ATTACKS. Filing Data: 30 Jun. 2017.

### DETAILED DESCRIPTION OF EMBODIMENTS

One embodiment of this invention describes a method and apparatus for capturing, classifying, and identification of all messages sent to or received from low complexity sensors or devices (sensors/devices) within a network, and then processing this information in order to identify hack attempts and also predict newly engineered malicious attacks. The type of messages sent might be found for example in an Internet of Things (IOT) network architecture, Smart Grid Home Area Networks (HAN), Smart Grid Home Energy Management System (HEMS), Smart Grid Enterprise Networks, Smart Home Networks, Medical patient sensor systems, Automotive networks, and Health/Biometric sensor systems. The Internet of Things (IoT) is a network of physical devices, vehicles, home appliances, and other items embedded with electronics, software, sensors, actuators, and connectivity which enables these things to connect and exchange data, creating opportunities for more direct integration of the physical world into computer-based systems, resulting in efficiency improvements, economic benefits, and reduced human exertions. However this should not restrict the applicability of any potential embodiment of this invention as described in this patent application.

The methods described in one embodiment of this invention are capable of supporting trillions of sensors/devices in an efficient and cost effective manner. As IOT and similar sensor/device networks become more pervasive, the requirement to reliably capture all messages in order to identify malicious attacks in the process of being launched, or to predict malicious attack probes becomes paramount. One embodiment of this invention presents such a method that can be used to monitor and protect networks efficiently and cost-effectively from a centralized site so that all network types can be protected.

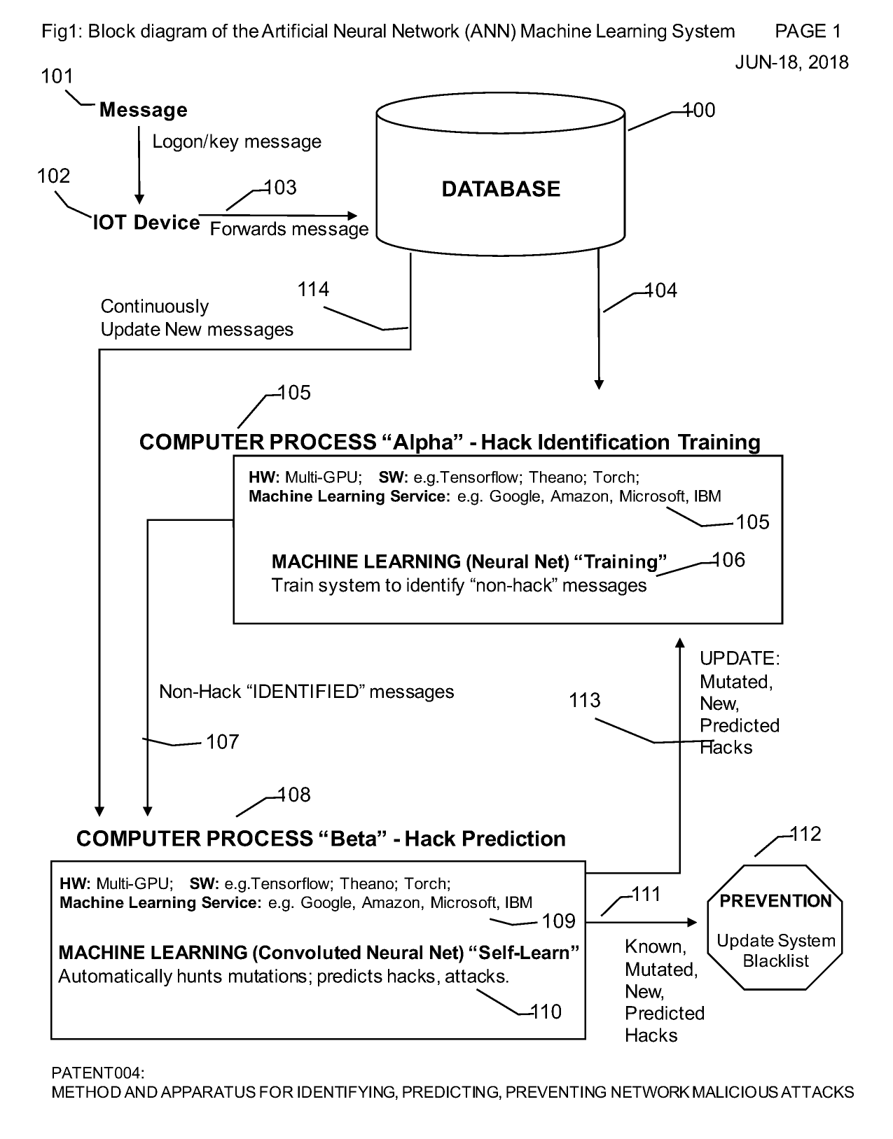

In one embodiment of this invention described below, the Block Diagram of the Machine Learning System (FIG. 1) outlines implementation of two separate computational phases which are fed data real-time from a network Database 100: COMPUTER PROCESS “ALPHA”—Hack Identification Training 105, and COMPUTER PROCESS “BETA”—Hack Prediction 108. This results in a real-time, continually updated and evolving list of hackers and viruses 112.

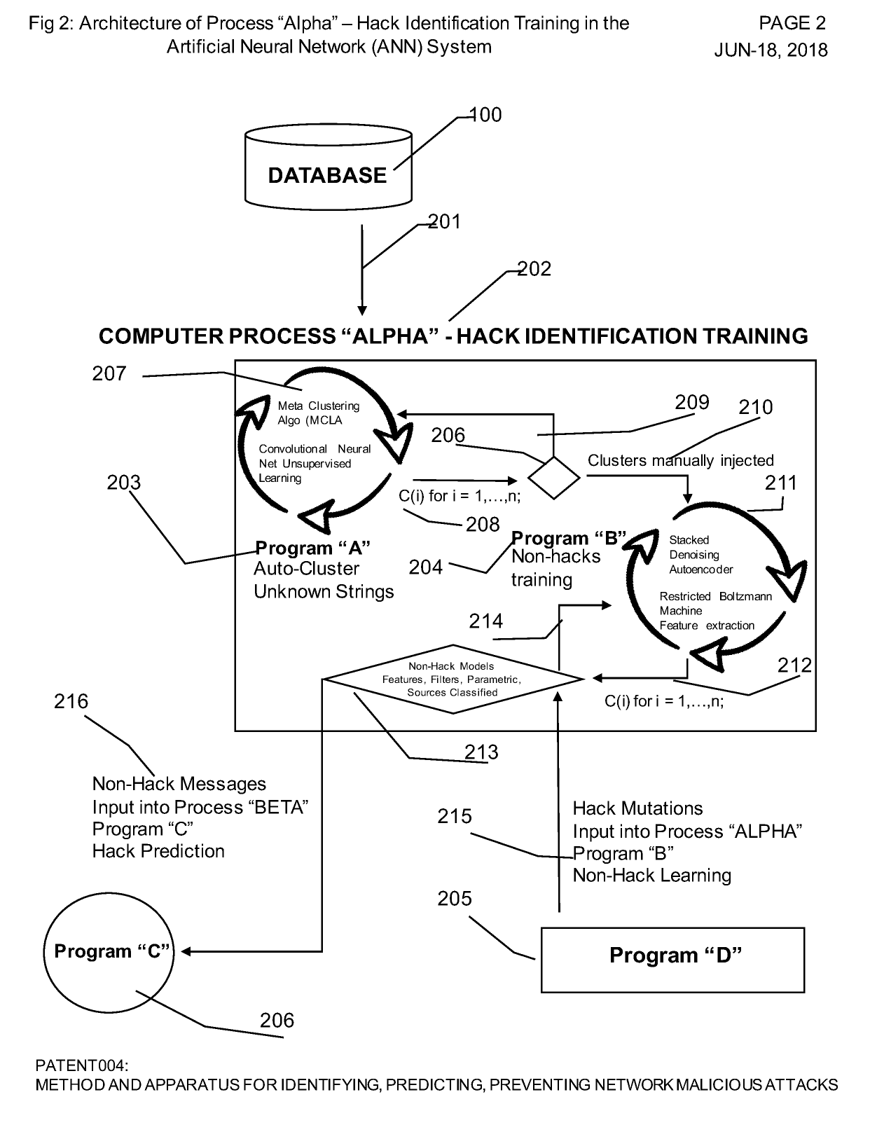

The first phase of the system is to use machine learning to train the system. This is the COMPUTER Process “Alpha”—Hack Identification Training (FIG. 2) 202: This consists of two (2) separate computer programs, the first Machine Learning Program “A” 203 trains a computer to classify all received encryption keys and/or network messages into similar, identifiable groups, or “CLUSTERS” based upon, for example, character or numeric patterns in the encryption keys and/or messages. Then a separate Machine Learning Program “B” 204 trains a computer to identify non-hacking sources with the aid of human experts to continually help train the system.

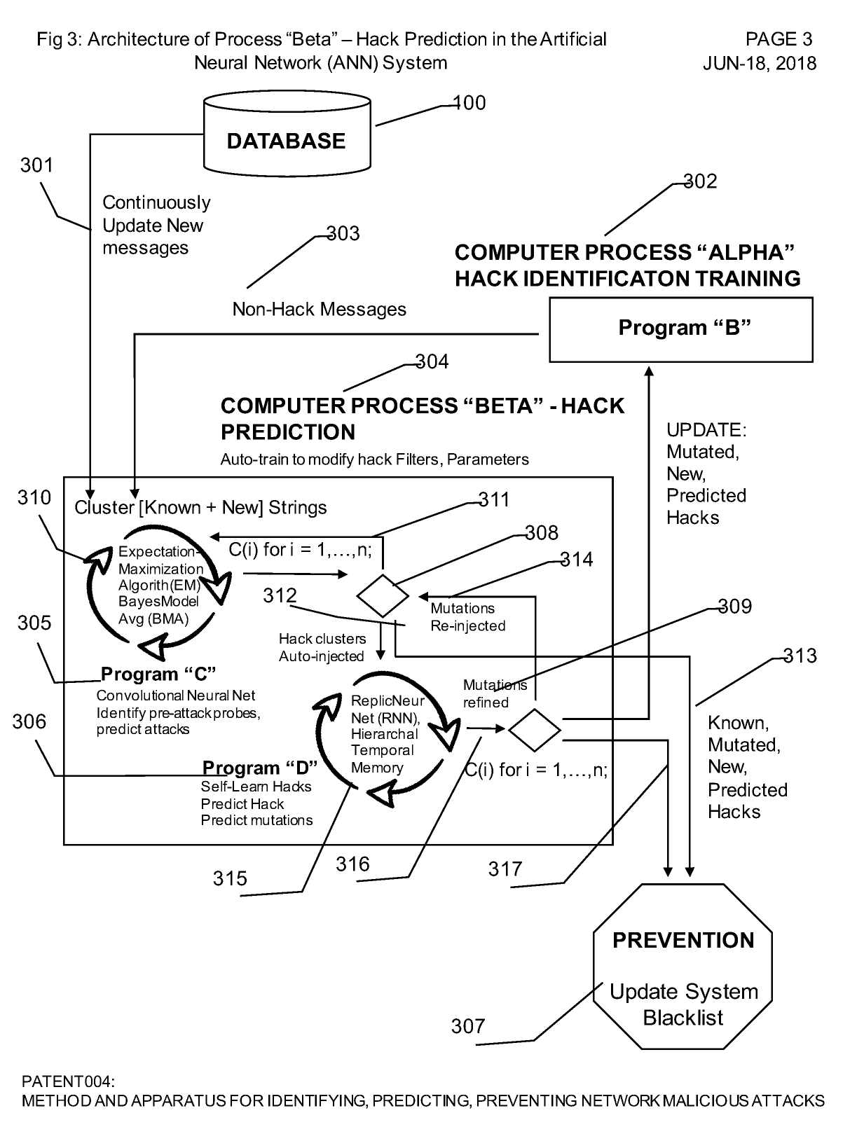

The second phase of the system is to use machine learning to predict new attacks and hacks. This is the COMPUTER Process “Beta”—Hack Prediction (FIG. 3) 304: consisting of two (2) separate computer programs, the first Self Learning Program “C” 305 trains a computer to both identify and predict new malicious attacks, and a second separate Machine Learning Program “D” 306 is trained to predict new or evolving malicious mutations in order to identify attacks in the process of forming.

In one embodiment of this invention, the Database (FIG. 2, FIG. 3) 100 stores all messages received from or sent to the network sensors or devices.

In one embodiment of this invention, the COMPUTER Process “Alpha”—Hack Identification Training 202, uses two (2) separate computers each operating an Artificial Neural Network (ANN) in a connectionist system enabled by open-source Machine Learning software, such as Tensor-Flow, Theano, Torch, or Caffe (see Table 1 for list of open-source repositories). The software will operate as two (2) separate programs each on a separate computer (FIG. 2): PROGRAM A 203 and PROGRAM B 204.

TABLE 1

| Software name (all the | Entity where the software began |
|---|---|
| software listed below is | or current entity where the |
| open-source software) | software may be downloaded |
| Tensor-Flow | Tensor-Flow.org |
| Theano | University of Montreal |
| Torch | Available from GitHub.com |
| Caffe | UC Berkeley, available |
| | from GitHub.com |

In one embodiment of this invention the COMPUTER Process “Alpha”—Hack Identification Training PROGRAM A 203 (FIG. 2) will cluster all the messages received by the end-devices and stored in the above referenced database. The Artificial Neural Network (ANN) will use the database contents to classify network messages based on patterns contained in the messages. These clustered messages are later used in COMPUTER Process “Beta” PROGRAM D 205 to reverse engineer the model used by the hacker to create the malicious messages. PROGRAM A 203 uses one or more well known and publicly available mathematical models such as, but not limited to, for example, a “Replicator Neural Net” (RNN), which is a model that predicts its own inputs and which enables creation of “outlier detection algorithms”. This allows the system to identify outliers or aberrant data from the data set which can then be removed or considered separately in regression modeling to improve accuracy. “Long-Short-Term-Memory (LSTM) Architecture” (building blocks of RNN), “Gradient Descent”, an optimization algorithm used in Machine Learning to find the vector values of parameters/coefficients of a mathematical function that minimizes a cost function, or “Back propagation” (in Machine Learning, backpropagation is commonly used by the Gradient descent optimization algorithm to adjust the weight of ANN neurons), or a “Meta Clustering Algorithm” (MCLA) procedure to first find a variety of clusterings of data (e.g. encryption keys or messages), and then in turn re-cluster this diverse set of clusterings so it is only necessary to examine a small number of qualitatively different clusterings which can then be grouped into clusterings of meta clusters.

In one embodiment of the invention the results from PROGRAM A 203 are then transmitted to other computers to perform the message clustering in a distributed and redundant computing architecture.

In one embodiment of this invention the COMPUTER Process “Alpha”—Hack Identification Training PROGRAM B 204 (FIG. 2) runs a second and separate ANN computational process. This second process utilizes as input the data resulting from the ANN model of PROGRAM A described previously. This second Machine Learning process PROGRAM B 204 uses one or more well known and publicly available mathematical models such as, but not limited to, for example, the well known “Restricted Boltzmann Machine” (a 2 layer ANN used for dimensionality reduction, classification, regression, collaborative filtering, feature learning, and modeling), as well as a “Stacked Denoising Autoencoder” which are multiple layers of autoencoders (ANNs that try to reconstruct its input for dimensionality reduction, feature selection and extraction) which then autoencode the previous autoencoder output (i.e. stacked), and then randomly corrupts its input (i.e. introducing noise) that the autoencoder must then reconstruct, or “denoise”. These models are used to identify and extract probable “non-hacking” messages from the clusters provided by PROGRAM A output, building a database of “whitelist” (REF:7) messages.

In one embodiment of this invention the PROGRAM B 204 Machine Learning computing model runs with the aid of a human-expert to supervise learning in order to train PROGRAM B to identify malicious messages building a “blacklist” (REF: 8).

In one embodiment of this invention, the COMPUTER Process “Beta”—Hack Prediction 304 (FIG. 3) has two (2) separate computers each operating an ANN in a connectionist system enabled by Machine Learning software such as Tensor-Flow, Theano, Torch, or Caffe to operate two (2) separate programs each on a separate computer (FIG. 3): PROGRAM C 305 and PROGRAM D 306.

In one embodiment of this invention the COMPUTER Process “:Beta”—Hack Prediction PROGRAM C 305 (FIG. 3) computer implements an ANN in a connectionist system employing Machine Learning computational models to identify probable malicious messages. PROGRAM C 305 does this by first taking the output of “known, safe” encryption keys and messages generated by PROGRAM B 204, and then comparing them to other/unknown messages. This allows PROGRAM C 305 to identify and learn “pre-attack” probe patterns from possible malicious sources. PROGRAM C 305 does so by grouping newly identified encryption keys and messages based on such possible factors as, but not limited to: never-before-seen patterns, geographic sources of new patterns, device/computer sources of new patterns, similarity to prior hacks, target similarity, known/common editing practices by hackers, algorithmic patterns of multiple encryption keys, timing/frequency pattern of probes based on prior attacks, and identifiable character patterns (signatures). In this manner PROGRAM C 305 can “learn” to predict malicious attacks as they are emerging through the ANN process. PROGRAM C 305 uses one or more well known and publicly available mathematical models such as, but not limited to, for example, the “Expectation Maximization Algorithm” (EM) which is an iterative method in statistics to find the maximum likelihood estimates of parameters in statistical models where the model depends on unobserved/inferred variables and the “Bayesian Model Averaging” (BMA) which uses Bayesian inference to weight an ANN model based on how well the ANN model explains the data rather than simply based on the last set of data inputs. In this manner PROGRAM C 305 can model malicious attack predictions.

In one embodiment of this invention it is assumed that the COMPUTER Process “Beta”—Hack Prediction PROGRAM D 306 (FIG. 3) computer will use Machine Learning to develop new or unseen hack mutations based on the latest identified and emerging attacks which result from PROGRAM C 305. PROGRAM D 306 will predict new, as yet “unseen” or “yet to be developed” hacks by examining the pattern of the “pre-attack” probes identified in PROGRAM C 305. It does so by grouping patterns of newly emerging attacks from PROGRAM C 305, and once having “learned” these new patterns, will extend these new hacking patterns to identify possible new and evolving malicious hacks. PROGRAM D 306 will then feed the hack mutations back into Process “Alpha”—Hack Identification Training PROGRAM B 204 (FIG. 2) so that PROGRAM B 204 can then continue to differentiate between hack and non-hack messages. PROGRAM D 306 (FIG. 3) uses one or more well-known and publicly available mathematical models such as, but not limited to, for example, a “Replicator Neural Net” (RNN) (see paragraph 32 above), or a “Hierarchal Temporal Memory”, (HTM) which is a machine learning algorithm inspired by the human neocortex and designed to learn sequences and make predictions based on space and time. With this time-series data of hacking attempts, HTM can use its learned sequences to perform time-dependent regression to predict emerging hacking attacks (i.e. new hacking mutations).

In one embodiment of this invention, COMPUTER Process “Alpha”—Hack Identification Training 202 (FIG. 2) running PROGRAM A 203 and PROGRAM B 204, and COMPUTER Process “Beta”—Hack Prediction 304 (FIG. 3) running PROGRAM C 305 and PROGRAM D 306 will operate continuously as the database is constantly updated with new network messages. In this way as low complexity sensors/devices constantly update the database with new messages, the system can endlessly analyze for malicious attacks in real-time, as well as continually learn, thus improving the detection performance.

In one embodiment of this invention, COMPUTER Process “Alpha”—Hack Identification Training 202 (FIG. 2) running PROGRAM A 203 and PROGRAM B 204, and COMPUTER Process “Beta”—Hack Prediction 304 (FIG. 3) running PROGRAM C 305 and PROGRAM D 306 will operate in two (2) separate installations using data from the same database so that results can be cross-checked. In this manner if there is any divergence in results, human experts can study the output in order to improve the system performance.

In one embodiment of this invention COMPUTER Process “Alpha”—Hack Identification Training 202 (FIG. 2) running PROGRAM A 203 and PROGRAM B 204, and COMPUTER Process “Beta”—Hack Prediction 304 (FIG. 3) running PROGRAM C 305 and PROGRAM D 306 will operate in separate installations with input from separate databases in order to reduce the processing load and identify malicious variants and mutations more rapidly from smaller and more restricted database sets, or from geographically diverse databases in order to reflect geographic behavioral differences of hackers.

Although the description of the invention has been described with respect to particular embodiments thereof, these particular embodiments are merely illustrative, and not restrictive. Other embodiments of the invention may be implemented.

Particular embodiments may be implemented by using a programmed general purpose digital computer, or by using application specific integrated circuits (ASIC), programmable logic devices (PLD), field programmable gate arrays (FPGA), optical, chemical, biological, quantum or nano-engineered systems, components and mechanisms. In general, the functions of particular embodiments can be achieved by any means as is known in the art. Distributed systems, networked systems, components, and/or circuits can be used for implementation. Communication, or transfer, of data may be achieved using wired, wireless, or by any other means.

It will also be appreciated that one or more of the elements depicted in the drawings or figures can also be implemented in a more separated manner or integrated manner, or even removed or rendered as inoperable in certain cases, so as to render the system to be useful in accordance with a particular application.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt to a particular situation or material without deviating from the essential scope and spirit of this invention.

We claim:

1. An apparatus comprising:
a. a sensor or device network system for communication with at least one sensor/device;
b. at least one database for storing at least one message sent or received on the communications network; and
c. at least one machine learning processor.

2. The communication system of claim 1 wherein the machine learning processor is an Artificial Neural Network (ANN).

3. The communication system of claim 1 wherein one or more databases are used to store network messages and results from the network sensors or devices.

4. The communication system of claim 1 wherein the machine learning processor is used to classify network messages into different identifiable clusters.

5. The communication system of claim 1 wherein the machine learning processor is trained to identify non-hacking messages found in the network.

6. The communication system of claim 1 wherein the machine learning processor is used to identify probable malicious attacks.

7. The communication system of claim 1 wherein the machine learning processor is used to predict new or emerging malicious mutations in order to identify attacks in the process of forming.

8. The communication system of claim 1 wherein the implementation uses independent databases and machine learning processors operating on a more restricted set of data.

9. A method comprising:
a. a sensor/device network for communication with at least one sensor/device database; and
b. each sensor or device is connected via a network to a plurality of databases; and
c. a database containing a plurality of messages received from the sensor or device network; and
d. the database connected to a plurality of machine learning processors; and
e. the plurality of the machine learning processors able to communication with the sensors or devices in the network.
f. two separate installations to crosscheck the results

10. The method in claim 9 further comprising the ability of the machine learning processor to classify all network messages into clusters.

11. The method in claim 9 further comprising the ability of the machine learning processor to identify non-hacking sources.

12. The method in claim 9 further comprising the ability of the machine learning processor to identify and predict new malicious attacks.

13. The method in claim 9 further comprising the ability of the machine learning processor to predict new or evolving malicious attacks.

14. The method in claim 9 further comprising the ability of the machine learning processor to use machine learning software such as Tensor-Flow.

15. The method in claim 12 further comprising the ability of the machine learning processor to aid human operators in identifying sources of malicious attacks.

16. The method in claim 12 further comprising the ability of the machine learning processor to shut down and otherwise incapacitate the sources of malicious attacks.

17. The method in claim 11 further comprising the ability of the machine learning processor to prevent further malicious attacks on the sensor or device network.

18. The method in claim 11 further comprising the ability of the machine learning processor to maintain the normal operation of the sensor or device network.

19. The method in claim 10 further comprising the ability of the machine learning processor to automatically identify hacking sources within the sensor or device network.

20. The method in claim 13 further comprising the ability of the machine learning processor to feedback newly predicted malicious hacks into the database to improve the performance of the hack identification process.
